(19) United States
(12) Patent Application Publication
(10) Pub. No.: US 2010/0243082 A1
(43) Pub. Date: Sep. 30, 2010

(54) Liquid isotope delivery system

(75) Inventors: Wuu-Jyh Lin, Longtan Shiang (TW); Mao-Hsung Chang, Longtan Shiang (TW); Kuo-Yuan Chu, Taipei City (TW); Dow-chi Chen, Longtan Shiang (TW); Ping-Yen Huang, Tongxiao Town (TW); Jenn-Tzong Chen, Daxi Town (TW); Ting-shien Duh, Daxi Town (TW)

Correspondence Address: Jackson Intellectual Property Group PLLC, 106 Starvale Lane, Shipman, VA, 22971, US

(73) Assignee: ATOMIC ENERGY COUNCIL - INSTITUTE OF NUCLEAR ENERGY RESEARCH, TAOYUAN (TW)

(21) Appl. No.: 11/980,743

(22) Filed: Oct. 31, 2007

(51) Int. Cl. F16K 15/00

(52) U.S. Cl. 137/512

(57) ABSTRACT

A liquid isotope delivery system includes a pressure-controlling unit, an input unit, a target chamber, a proton-radiating unit and a storage unit. The pressure-controlling unit includes a first regulating valve, a second regulating valve connected to the first regulating valve and a third regulating valve connected to the first regulating valve. The input unit is connected to the second regulating valve. The target chamber is connected to the third regulating valve and the input unit. The proton-radiating unit is located near the target chamber. The storage unit is connected to the target chamber.

### BACKGROUND OF INVENTION

1. Field of Invention

The present invention relates to a liquid isotope delivery system and, more particularly, to a liquid isotope delivery system that can stabilize the pressure of liquid isotope, thus ensuring security.

2. Related Prior Art

Positron emission tomography (“PET”) is developing fast around the world. Fluorine-18 fluoride made by a liquid target technology is the primary nucleus used in the PET. Fluorine-18 fluoride targets are used in almost every cyclotron center. Based on fluorine-18 fluorination labeling, fluorine-18 fluoride targets are used in various chemicals, thus providing PET radiopharmaceuticals. A liquid target delivery system is important for providing stable radiation on the fluorine-18 fluoride while delivering the same because the half-life of the fluorine-18 fluoride is only 110 minutes. Therefore, a liquid target delivery system is used in almost every cyclotron center.

While making liquid isotope, a worker draws a predetermined amount of liquid from a storage bottle. The liquid is oxygen-18 water for example. Then, the worker opens a liquid-injecting valve and a gas-venting valve of a target chamber to inject the liquid into the target chamber. After that, the worker closes the liquid-injecting valve and the gas-venting valve, but opens a pressurizing valve to supply fluorine into the target chamber. Now, the target chamber is irradiated with a proton beam for causing the oxygen-18 water to react with the fluorine, thus providing fluorine-18 water.

The worker injects the oxygen-18 water into the target chamber before irradiating the oxygen-18 water and the fluorine. It is however difficult for the worker to precisely inject a desired amount of oxygen-18 water into the target chamber. Moreover, the safety of the worker could be jeopardized because of the intense radiation in the target chamber. Furthermore, the proton beam inevitably entails unstable pressure of the liquid isotope.

### SUMMARY OF INVENTION

It is the primary objective of the present invention to provide a liquid isotope delivery system that can stabilize the pressure of liquid isotope, thus ensuring security.

To achieve the foregoing objective, the liquid isotope delivery system includes a pressure-controlling unit, an input unit, a target chamber, a proton-radiating unit and a storage unit. The pressure-controlling unit includes a first regulating valve, a second regulating valve connected to the first regulating valve and a third regulating valve connected to the first regulating valve. The input unit is connected to the second regulating valve. The target chamber is connected to the third regulating valve and the input unit. The proton-radiating unit is located near the target chamber. The storage unit is connected to the target chamber.

Other objectives, advantages and features of the present invention will become apparent from the following description referring to the attached drawings.

### BRIEF DESCRIPTION OF DRAWINGS

The present invention will be described via the detailed illustration of the preferred embodiment referring to the drawings.

FIG. 1 is a block diagram of a liquid isotope delivery system according to the preferred embodiment of the present invention.

FIG. 2 is a more detailed block diagram of the liquid isotope delivery system shown in FIG. 1.

FIG. 3 shows a first mode of operation of the liquid isotope delivery system shown in FIG. 2.

FIG. 4 shows a second mode of operation of the liquid isotope delivery system shown in FIG. 2.

FIG. 5 shows a third mode of operation of the liquid isotope delivery system shown in FIG. 2.

### DETAILED DESCRIPTION OF PREFERRED EMBODIMENT

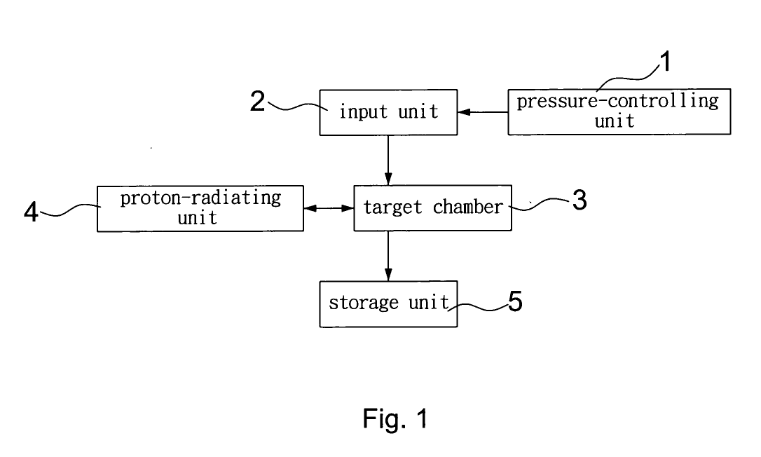

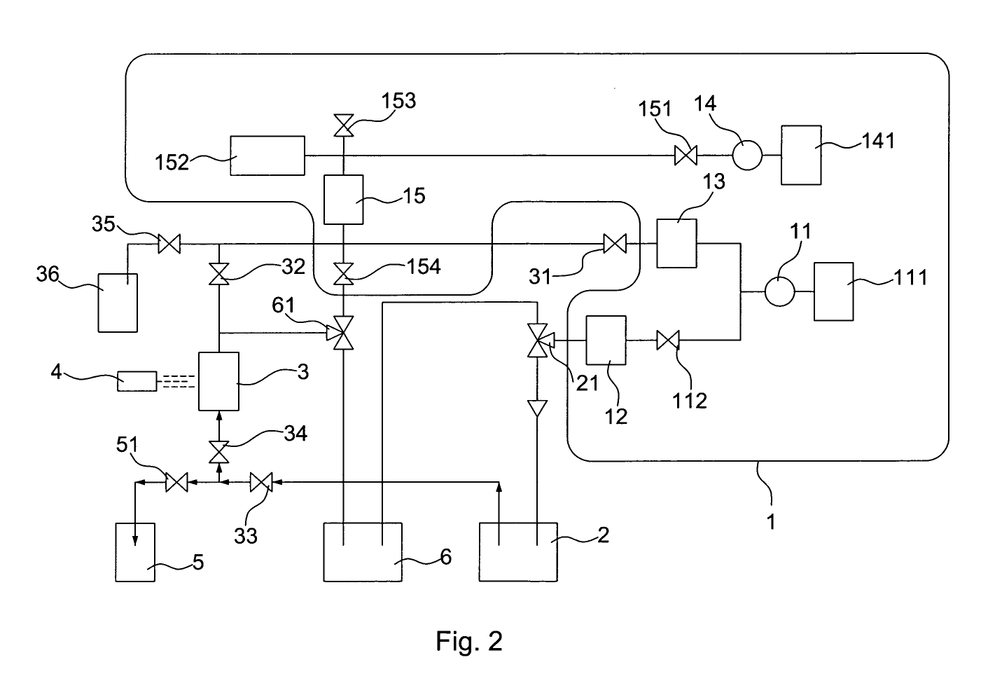

Referring to FIGS. 1 and 2, a liquid isotope delivery system includes a pressure-controlling unit 1, an input unit 2, a target chamber 3, a proton-radiating unit 4, a storage unit 5 and a cleaning unit 6 according to the preferred embodiment of the present invention. The liquid isotope delivery system can stabilize the pressure of liquid isotope while making and delivering the same, thus ensuring security.

The pressure-controlling unit 1 includes a first regulating valve 11, a second regulating valve 12, a third regulating valve 13, a fourth regulating valve 14 and a pressure regulator 15. The first regulating valve 11 is a high-pressure regulating valve. The first regulating valve 11 is connected to a gas tank 111.

The second regulating valve 12 is a low-pressure regulating valve. The second regulating valve 12 is connected to the first regulating valve 11. An on/off element 112 is provided between the first regulating valve 11 and the second regulating valve 12.

The third regulating valve 13 is a low-pressure regulating valve. The third regulating valve 13 is connected to the first regulating valve 11.

The fourth regulating valve 14 is connected to a gas tank 141.

The pressure regulator 15 is connected to the fourth regulating valve 14. An on/off element 151 is provided between the pressure regulator 15 and the fourth regulating valve 14. A pressure transducer 152 is connected to the pressure regulator 15. An on/off element 153 is connected to the pressure regulator 15.

The input unit 2 is connected to the second regulating valve 12. An on/off element 21 is provided between the input unit 2 and the second regulating valve 12.

The target chamber 3 is connected to the third regulating valve 13. Two on/off elements 31 and 32 are provided between the target chamber 3 and the third regulating valve 13. The target chamber 3 is connected to the input unit 2. Two on/off elements 33 and 34 are provided between the target chamber 3 and the input unit 2. A recovery bottle 36 is connected to the third regulating valve 13. An on/off element 35 is provided between the recovery bottle 36 and the third regulating valve 13.

The proton-radiating unit 4 is located near the target chamber 3.

The storage unit 5 is connected to the target chamber 3. An on/off element 51 is provided between the storage unit 5 and the target chamber 3. The storage unit 5 is connected to the input unit 2.

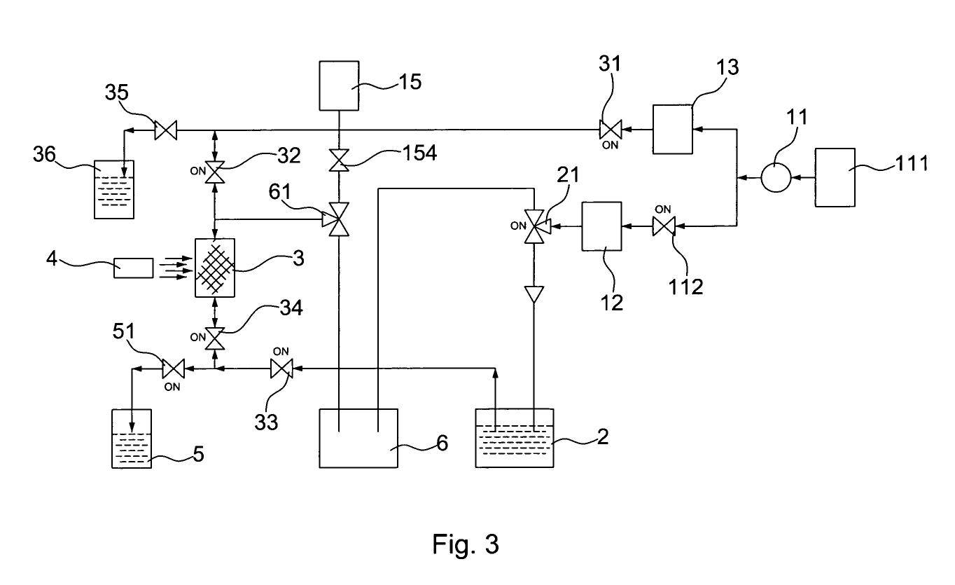

Referring to FIG. 3, in a first mode of operation, oxygen-18 water is provided from the input unit 2. Then, the on/off elements 112, 21, 33 and 34 and the regulating valves 11 and 12 are opened so that the gas tank 111 provides gas to the first regulating valve 11, and provides gas to the input unit 2 through the second regulating valve 12. Thus, the oxygen-18 water is introduced into the target chamber 3 from the input unit 2. The on/off elements 32 and 35 are opened so that an overflow portion of oxygen-18 water is introduced into the recovery bottle 36. The proton-radiating unit 4 radiates a high-energy proton beam to turn the oxygen-18 water in the target chamber 3 into fluorine-18 water. After that, the on/off elements 31 and 51 and the third regulating valve 13 are opened, thus allowing gas to travel into the target chamber 3 from the first regulating valve 11 through the third regulating valve 13, thus introducing the fluorine-18 water into the storage unit 5.

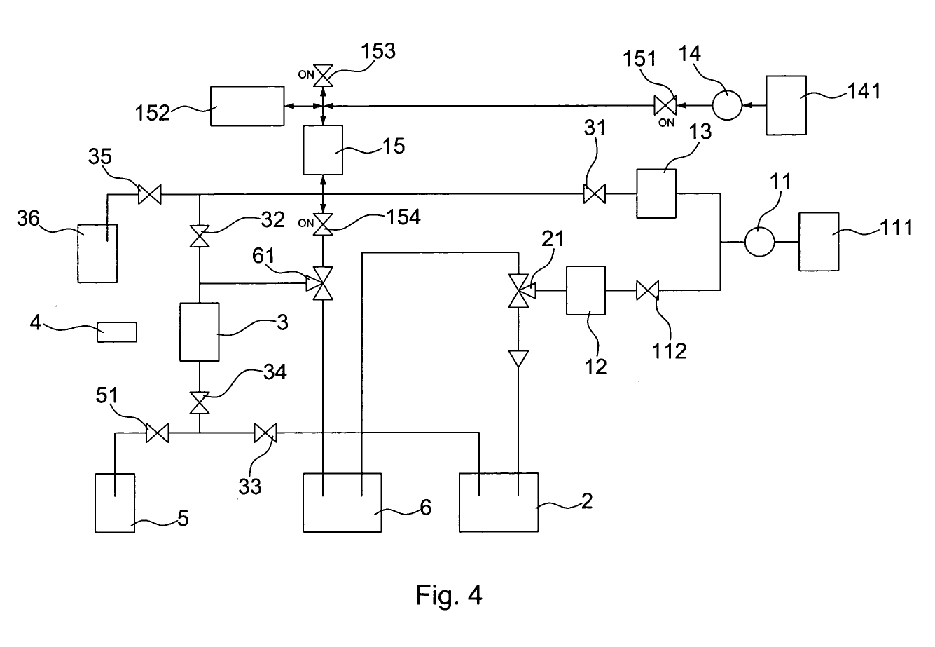

Referring to FIG. 4, in a second mode of operation, the on/off element 154 is opened as well as the regulating valves 11, 12 and 13 in the radiation of the proton beam. The pressure regulator 15 cooperates with the pressure transducer 152 to constantly detect the pressure in the regulating valves 12, 13 and 14. If the pressure is too high, the on/off let 153 will be opened to reduce the pressure. If the pressure is too low, the on/off element 151 will be opened to allow the gas tank 141 to supply gas through the fourth regulating valve 14 under the control of the pressure regulator 15. Therefore, the pressure of the liquid isotope delivery system is retained in a predetermined range.

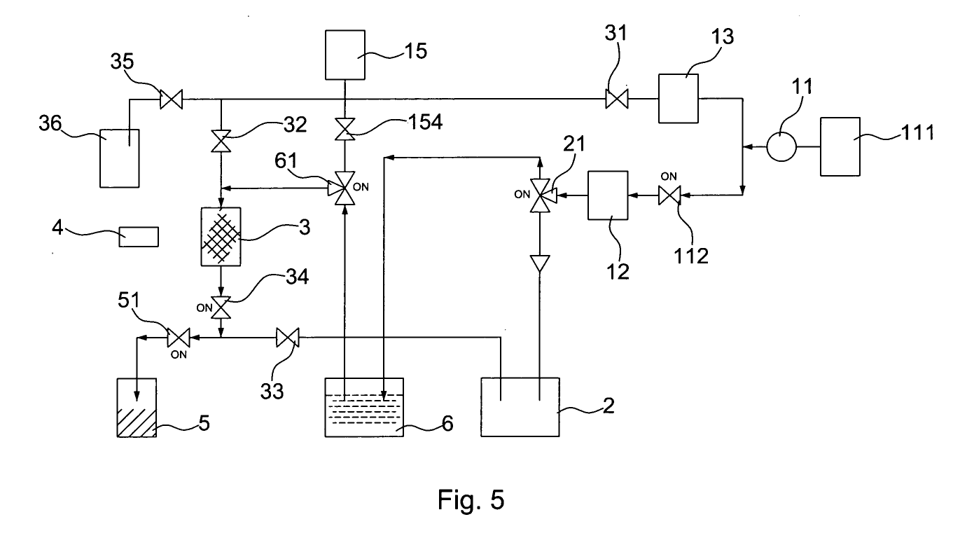

Referring to FIG. 5, in a third mode of operation, when the radiation of the proton beam is finished, the on/off elements 112, 21, 61, 34 and 51 are closed. Cleaning liquid or water is provided from the cleaning unit 6. The adjusting valves 11 and 12 are opened to allow the gas tank 111 to provide gas into the first regulating valve 11, and provide gas into the cleaning unit 6 through the second regulating valve 12. Thus, the cleaning liquid or water is introduced into the target chamber 3. Then, wastewater is released from the storage unit 5.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A liquid isotope delivery system comprising:
a pressure-controlling unit comprising a first regulating valve, a second regulating valve connected to the first regulating valve and a third regulating valve connected to the first regulating valve;
an input unit connected to the second regulating valve;
a target chamber connected to the third regulating valve and the input unit;
a proton-radiating unit located near the target chamber; and
a storage unit connected to the target chamber.

2. The liquid isotope delivery system according to claim 1, wherein the first regulating valve is a high-pressure regulating valve.

3. The liquid isotope delivery system according to claim 2 comprising a gas tank connected to the first regulating valve.

4. The liquid isotope delivery system according to claim 1 comprising an on/off element between the first and second regulating valves.

5. The liquid isotope delivery system according to claim 1 comprising
a cleaning unit connected to the second regulating valve on one hand and connected to the target chamber on the other hand; and
an on/off element between the cleaning unit and the target chamber.

6. The liquid isotope delivery system according to claim 1 comprising an on/off element between the second regulating valve and the input unit.

7. The liquid isotope delivery system according to claim 1, wherein the second and third regulating valves are low-pressure regulating valves.

8. The liquid isotope delivery system according to claim 1 comprising two valves between the third regulating valve and the target chamber.

9. The liquid isotope delivery system according to claim 1 comprising:
a pressure regulator connected to the third regulating valve;
an on/off element between the pressure regulator and the third regulating valve;
a gas tank connected to the pressure regulator
a fourth regulating valve connected to the gas tank;
another on/off element between the fourth regulating valve and the pressure regulator;
a pressure transducer connected to the pressure regulator; and
another on/off element between the pressure regulator and the second regulating valve.

10. The liquid isotope delivery system according to claim 1 comprising two on/off elements between the input unit and the target chamber.

11. The liquid isotope delivery system according to claim 1, wherein the input unit supplies oxygen-18 water.

12. The liquid isotope delivery system according to claim 1 comprising an on/off element between the target chamber and the storage unit.

13. The liquid isotope delivery system according to claim 1 comprising:
a recovery bottle connected to the target chamber; and
an on/off element between the recovery bottle and the target chamber.
